(19) United States
(12) Patent Application Publication
(10) Pub. No.: US 2011/0029757 A1
(43) Pub. Date: Feb. 3, 2011

(54) STREAM PROCESSOR AND TASK MANAGEMENT METHOD THEREOF

(75) Inventor: Hiroyuki NAKAJIMA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 12/825,868

(22) Filed: Jun. 29, 2010

(30) Foreign Application Priority Data
Jul. 30, 2009 (JP) 2009-177715

(51) Int. Cl. G06F 15/76; G06F 9/02

(52) U.S. Cl. 712/34; 712/E09.002

(57) ABSTRACT

A stream processor includes a programmable main processor MP, and a coprocessor CP that executes an extension instruction, the extension instruction being different from a basic instruction executed by the main processor MP. The main processor MP includes a coprocessor controller CPC outputting the extension instruction to the coprocessor CP, and the coprocessor CP includes a task controller TC, the task controller controlling a task performed based on the extension instruction and outputting status information ST of the task on every clock. The coprocessor controller CPC controls the coprocessor CP based on the status information ST and a basic instruction executed by the main processor MP in background in advance.

### INCORPORATION BY REFERENCE

This application is based upon and claims the benefit of priority from Japanese patent application No. 2009-177715, filed on Jul. 30, 2009, the disclosure of which is incorporated herein in its entirety by reference.

### BACKGROUND

1. Field of the Invention

The present invention relates to a stream processor and a task management method thereof, and more specifically, to a stream processor including a coprocessor and a task management method thereof.

2. Description of Related Art

An information processing apparatus often includes a processor specialized for a specific application including image processing or speech processing, for example (hereinafter referred to as application-oriented processor). Such an application-oriented processor includes a DSP (Digital Signal Processor) or a media processor, for example. The application-oriented processor mitigates the load of a CPU (Central Processing Unit) and improves processing ability of a whole information processing apparatus.

The above application-oriented processor further includes a stream processor, which is capable of executing stream processing to address ever-increasing volumes of data. For example, a stream processor disclosed in FIG. 1 of Japanese Unexamined Patent Application Publication No. 2006-338538 includes a DMA (Direct Memory Access) circuit and a FIFO (First In First Out) buffer, and is capable of executing the stream processing. However, in the stream processor disclosed in Japanese Unexamined Patent Application Publication No. 2006-338538, the task management such as changing status or adding extension processing cannot be executed in the middle of the stream processing.

Meanwhile, Published Japanese Translation of PCT International Publication for Patent Application, No. 2005-532604 discloses in FIG. 4 a stream processor including a programmable main processor (core) and a coprocessor. In such a structure, the task management can be performed by interruption processing including notification of interruption start from the main processor and notification of interruption end from the coprocessor.

### SUMMARY

However, the task management in the stream processor disclosed in Published Japanese Translation of PCT International Publication for Patent Application, No. 2005-532604 requires interruption processing as stated above. Hence, the stream processing executed by the coprocessor is interrupted until the end of the interruption processing. In other words, the stream processor disclosed in Published Japanese Translation of PCT International Publication for Patent Application, No. 2005-532604 is not suitable for real-time control that requires high-speed operation.

A first exemplary aspect of the present invention is a stream processor including a programmable main processor, and a coprocessor that executes an extension instruction, the extension instruction being different from a basic instruction executed by the main processor, in which the main processor includes a coprocessor controller, the coprocessor controller outputting the extension instruction to the coprocessor, the coprocessor includes a task controller, the task controller controlling a task performed based on the extension instruction and outputting status information of the task, and the coprocessor controller controls the coprocessor based on the status information and a basic instruction executed by the main processor in background in advance.

A second exemplary aspect of the present invention is a task management method of a stream processor, the stream processor including a programmable main processor and a coprocessor, the coprocessor executing an extension instruction which is different from a basic instruction executed by the main processor, in which the main processor outputs the extension instruction to the coprocessor, the coprocessor outputs status information of a task performed based on the extension instruction, and the main processor controls the coprocessor based on the status information and a basic instruction executed by the main processor in background in advance.

The coprocessor is controlled by the status information of a task output from the coprocessor and the basic instruction executed by the main processor in the background in advance. Thus, the stream processor is suitable for real-time control.

According to the present invention, it is possible to provide a stream processor that is suitable for real-time control.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a stream processor according to a first exemplary embodiment;

FIG. 2 is a schematic diagram of a system according to the first exemplary embodiment;

FIG. 3 is a timing chart of image processing executed by the stream processor according to the first exemplary embodiment;

FIG. 4 is a detailed block diagram of a multi-task coprocessor controller and a task controller according to the first exemplary embodiment;

FIG. 5 is a timing chart showing pipeline processing executed by the stream processor according to the first exemplary embodiment; and

FIG. 6 is a block diagram of a stream processor according to a second exemplary embodiment.

### DETAILED DESCRIPTION OF THE EXEMPLARY EMBODIMENTS

The specific exemplary embodiments of the present invention will be described in detail with reference to the drawings. It should be noted, however, the present invention is not limited to the exemplary embodiments described below. Further, description and drawings are simplified as appropriate for the sake of clarity.

### First Exemplary Embodiment

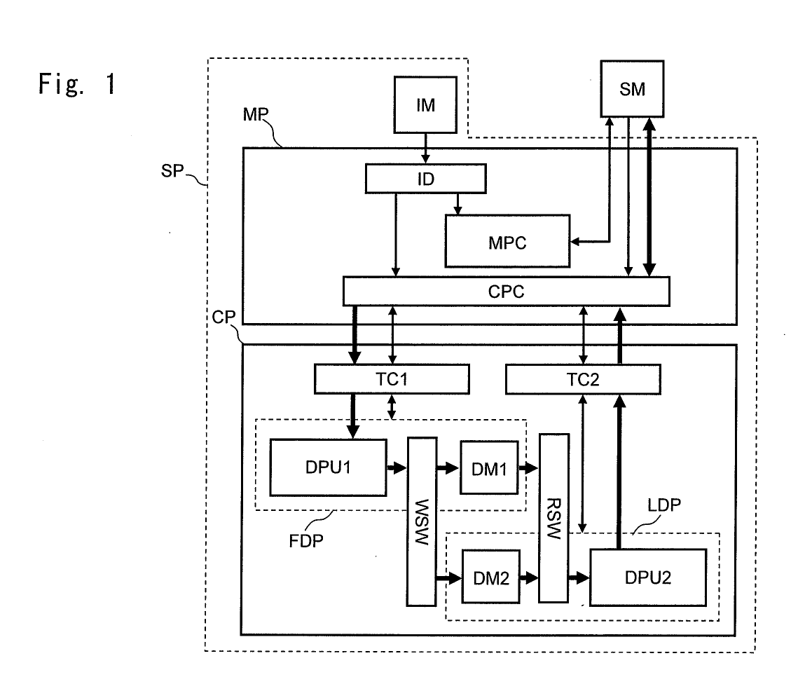

FIG. 1 is a block diagram of a stream processor according to a first exemplary embodiment of the present invention. A stream processor SP includes, as shown in FIG. 1, an instruction memory IM, a main processor MP, and a multi-task coprocessor CP. The main processor MP is a programmable processor which can be controlled with programs. Further, the multi-task coprocessor CP is able to perform task operation which is independent from task operation executed by the main processor MP.

The main processor MP includes an instruction decoder ID, a main processor controller MPC, and a multi-task coprocessor controller CPC. Further, the multi-task coprocessor CP includes task controllers TC1 and TC2, data processing units DPU1, DPU2, data memories DM1 and DM2, a write switch WSW, and a read switch RSW.

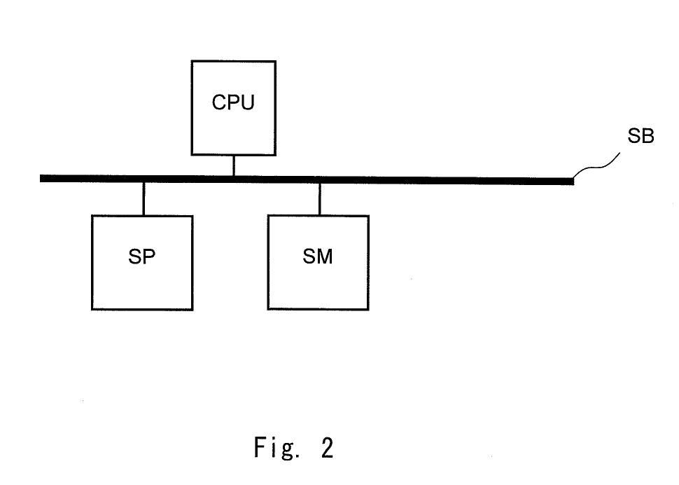

FIG. 2 is a schematic diagram of a system according to the first exemplary embodiment. A CPU (Central Processing Unit), a stream processor SP, and a shared memory SM are connected to a system bus SB. In short, the CPU and the stream processor SP share the shared memory SM. The stream processor SP according to the first exemplary embodiment shown in FIGS. 1 and 2 is a DSP (Digital Signal Processor) specialized for image processing or speech processing, for example. However, the applications and the types of the processor are not limited.

The elements of the stream processor SP shown in FIG. 1 will now be described in order. In FIG. 1, thin arrows show a flow of control signals such as instructions, and thick arrows show a flow of image data. The instruction memory IM is a memory that stores instructions. For example, a series of instructions for image processing are stored. The instruction memory IM may be a ROM (Read Only memory) that stores predetermined instructions in advance, or may be a flash memory or the like that temporarily stores an instruction read out from an external memory (not shown).

The instruction decoder ID decodes each instruction fetched from the instruction memory IM to the main processor MP. The instruction that is decoded is input to the main processor controller MPC or the multi-task coprocessor controller CPC according to the instruction.

The main processor controller MPC controls the main processor MP based on the instruction input from the instruction decoder ID. The main processor MP performs, for example, initial setting and calculation of parameters for image processing. The calculation of parameters for image processing is performed using a parameter table stored in the shared memory SM based on the instructions from a CPU, for example. The parameters calculated by the main processor MP are stored in the shared memory SM, and then input to the multi-task coprocessor CP through the multi-task coprocessor controller CPC.

Even while the multi-task coprocessor controller CPC and the multi-task coprocessor CP operate, the main processor controller MPC is able to stop only the clock supplied to an operation unit (not shown) of the main processor MP. Accordingly, low power consumption can be attained.

On the other hand, the multi-task coprocessor controller CPC controls the multi-task coprocessor CP based on the instruction input from the instruction decoder ID. More specifically, the multi-task coprocessor controller CPC issues an extension instruction based on the instruction input from the instruction decoder ID. In the first exemplary embodiment, two extension instructions are input to the task controllers TC1 and TC2 that are provided in the multi-task coprocessor CP. The control of the multi-task coprocessor CP by the multi-task coprocessor controller CPC can be performed exclusively, independently from the main processor controller MPC.

Input and output of the control signals between the multi-task coprocessor controller CPC and the multi-task coprocessor CP are executed through a control interface. The control interface may be a logical interface, or a physical interface using a shared bus.

The task controllers TC1 and TC2 decode the extension instructions input from the multi-task coprocessor controller CPC. The two extension instructions that are decoded are input to a former data path FDP and a latter data path LDP. The former data path FDP and the latter data path LDP perform image processing based on the extension instructions input from the task controllers TC1 and TC2, respectively.

In summary, the stream processing in the stream processor SP according to the first exemplary embodiment includes two-stage image processing. The detail of the multi-task coprocessor controller CPC and the task controllers TC1 and TC2 will be described later.

The flow of the image data will be described first, and then the former data path FDP and the latter data path LDP will be described next. First, the image data that is received is stored in the shared memory SM. This image data is input to the data processing unit DPU1 of the former data path FDP through the multi-task coprocessor controller CPC and the task controller TC1.

Data input and data output between the multi-task coprocessor controller CPC and the multi-task coprocessor CP are executed through a data interface. The data interface may be a logical interface, or a physical interface using a shared bus.

The image data input to the data processing unit DPU1 is processed based on the extension instruction. The image data that is processed is temporarily stored in one of the data memory DM1 and the data memory DM2 selected by the write switch WSW. The write switch WSW switches the data bus to write data into the data memory DM1 or the data memory DM2.

The image data stored in the data memory DM1 or the data memory DM2 is selected by the read switch RSW, and is input to the data processing unit DPU2. The read switch RSW switches the data bus to read out data stored in the data memory DM1 or the data memory DM2. The image data input to the data processing unit DPU2 is processed based on the extension instruction.

As stated above, the image data which is processed in two stages by the data processing unit DPU1 and the data processing unit DPU2 is stored in the shared memory SM through the task controller TC2 and the multi-task coprocessor controller CPC.

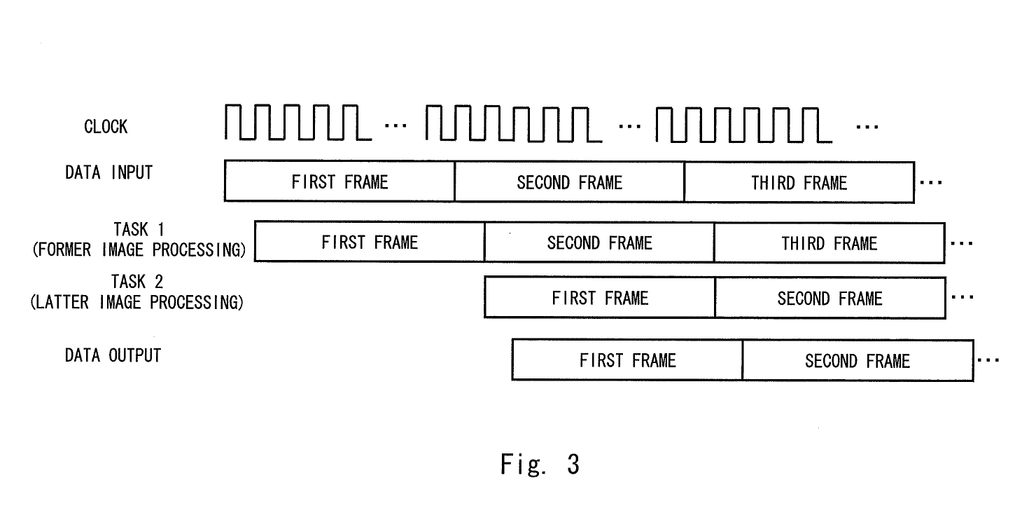

Referring next to FIG. 3, the image processing operation will be described. FIG. 3 is a timing chart of the image processing by the stream processor SP according to the first exemplary embodiment, and shows a flow of the image data. FIG. 3 shows, from the top to the bottom, clock, data input, task 1 (former image processing: image processing executed by the data processing unit DPU1 in FIG. 1), task 2 (latter image processing: image processing executed by the data processing unit DPU2 in FIG. 1), and data output.

As shown in “data input” of FIG. 3, the image data (stream) is input in order of first frame, second frame, third frame, and so on. Then, as shown in “task 1 (former image processing)” of FIG. 3, the image processing of the first frame is started by the data processing unit DPU1 with one clock delay from the input of the first frame in this example. When the data memory DM1 is selected by the write switch WSW, for example, the image data which is processed in the data processing unit DPU1 is stored in the data memory DM1.

When the image processing of the second frame is started by the data processing unit DPU1, the data memory DM2 is selected by the write switch WSW, and the image data processed by the data processing unit DPU1 is stored in the data memory DM2.

At the same time, as shown in “task 2 (latter image processing)” in FIG. 3, the image processing of the first frame stored in the data memory DM1 is started by the data processing unit DPU2. In this case, the data memory DM1 is selected by the read switch RSW. Then, as shown in “data output” in FIG. 3, the first frame after image processing is output with one clock delay from the image processing executed by the data processing unit DPU2 in this example.

As stated above, the image processing of the second frame (task 1) by the data processing unit DPU1 and the image processing of the first frame (task 2) by the data processing unit DPU2 are processed in parallel, which means a multi-task operation is executed. Although the number of data paths or the number of tasks performed in parallel is two in the first exemplary embodiment, three or more tasks may be performed in parallel by increasing the number of data paths.

Next, when the image processing of the third frame by the data processing unit DPU1 is started, the data memory DM1 is selected again by the write switch WSW, and the image data which is processed by the data processing unit DPU1 is stored in the data memory DM1.

At the same time, the image processing of the second frame stored in the data memory DM2 is started by the data processing unit DPU2. Then, the second frame after image processing is output. Subsequent frames including the third frame are processed in the similar way.

In this way, the data memories DM1 and DM2 that store the image data processed by the data processing unit DPU1 and the data memories DM1 and DM2 that store the image data read out by the data processing unit DPU2 are complementarily switched. Therefore, the former data path FDP including the data processing unit DPU1 and the latter data path LDP including the data processing unit DPU2 may successively execute parallel processing with no conflict.

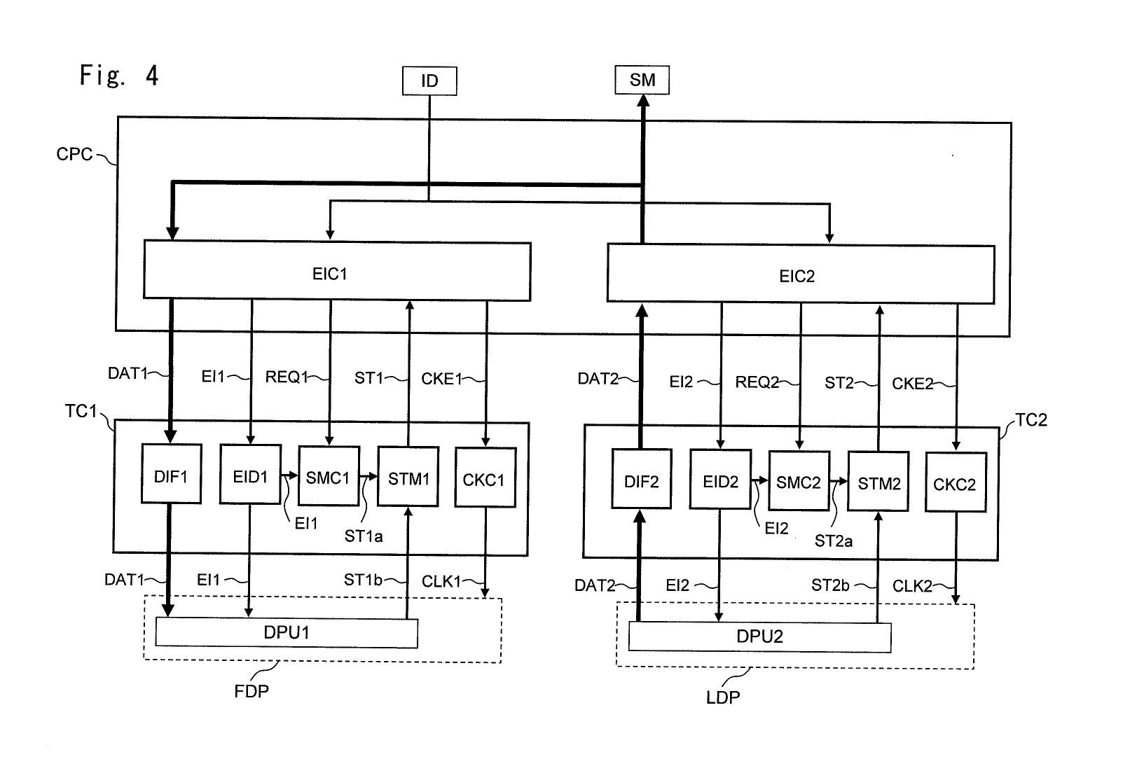

FIG. 4 is a detailed block diagram of the multi-task coprocessor controller CPC and the task controllers TC1 and TC2 of the first exemplary embodiment. As shown in FIG. 1, the multi-task coprocessor controller CPC is provided in the main processor MP, and the task controllers TC1 and TC2 are provided in the multi-task coprocessor CP.

As shown in FIG. 4, the multi-task coprocessor controller CPC includes two extension instruction controllers EIC1 and EIC2. Further, the task controller TC1 includes a data interface DIF1, an extension instruction decoder EID1, a state machine SMC1, a status memory STM1, and a clock controller CKC1. Further, the task controller TC2 shown in FIG. 1 includes a data interface DIF2, an extension instruction decoder EID2, a state machine SMC2, a status memory STM2, and a clock controller CKC2.

The extension instruction controller EIC1 issues an extension instruction EI1, a request signal REQ1, and a clock enable signal CKE1 based on an instruction input from the instruction decoder ID. The extension instruction EI1 is input to the extension instruction decoder EID1 of the task controller TC1. The extension instruction decoder EID1 decodes the extension instruction EI1 input from the extension instruction controller EIC1, and outputs the decoded extension instruction EI1 to the data processing unit DPU1 and the state machine SMC1. The data processing unit DPU1 executes the image processing based on the extension instruction EI1.

The request signal REQ1 is input to the state machine SMC1 of the task controller TC1. The state machine SMC1 issues a status information ST1a based on the decoded extension instruction EI1 and the request signal REQ1. The status information ST1a is stored in the status memory STM1.

Further, a status information ST1b input from the data processing unit DPU1 is also stored in the status memory STM1. The status information ST1a and ST1b stored in the status memory STM1 are selectively fed back to the extension instruction controller EIC1 as the status information ST1 for every clock. Note that only one of the status information ST1a and ST1b may be fed back to the extension instruction controller EIC1.

The extension instruction controller EIC1 is able to manage the tasks of the multi-task coprocessor CP by fine timing control on every clock. This management is performed based on the basic instruction which is processed in the background by the main processor MP and the status information ST1 which is fed back. The background processing is independently executed by the main processor MP while the multi-task coprocessor CP executes the stream processing. For example, in the specific status, the extension instruction controller EIC1 issues a new extension instruction to the task controller TC1 based on the basic instruction processed in the background by the main processor MP. Various types of control over the task controller TC1 may be possible such as instructing the task controller TC1 to start or stop the task executed by the data processing unit DPU1.

The clock enable signal CKE1 is input to the clock controller CKC1 of the task controller TC1. The clock controller CKC1 outputs a clock CLK1 based on the clock enable signal CKE1. The former data path FDP is operated based on the clock CLK1. Since the clock CLK1 is output from the clock controller CKC1 only when the clock enable signal CKE1 is input, power consumption can be reduced. Note that the clock supply/stop may be controlled for every component of the data processing unit DPU1 that is included in the former data path FDP, or the data memory DM1 or DM2.

The image data DAT1 stored in the shared memory SM is input to the data processing unit DPU1 through the extension instruction controller EIC1 and the data interface DIF1, and is processed.

Similarly, the extension instruction controller EIC2 issues an extension instruction EI2, a request signal REQ2, and a clock enable signal CKE2 based on an instruction input from the instruction decoder ID. The extension instruction EI2 is input to the extension instruction decoder EID2 of the task controller TC2. The extension instruction decoder EID2 decodes the extension instruction EI2 input from the extension instruction controller EIC2, and outputs the decoded extension instruction EI2 to the data processing unit DPU2 and the state machine SMC2. The data processing unit DPU2 executes the image processing based on the extension instruction EI2.

The request signal REQ2 is input to the state machine SMC2 of the task controller TC2. The state machine SMC2 issues a status information ST2a based on the decoded extension instruction EI2 and the request signal REQ2. The status information ST2a is stored in the status memory STM2.

Further, a status information ST2b input from the data processing unit DPU2 is also stored in the status memory STM2. The status information ST2a and ST2b stored in the status memory STM2 are selectively fed back to the extension instruction controller EIC2 as a status information ST2. Only one of the status information ST2a and ST2b may be fed back to the extension instruction controller EIC2.

The extension instruction controller EIC2 is able to manage the tasks of the multi-task coprocessor CP by fine timing control on every clock. This management is performed based on the basic instruction processed in the background by the main processor MP and the status information ST2 which is fed back. For example, in the specific status, the extension instruction controller EIC2 issues a new extension instruction to the task controller TC2 based on the basic instruction processed in the background by the main processor MP. Other various types of control over the task controller TC2 may be possible such as instructing the task controller TC2 to start or stop the task executed by the data processing unit DPU2.

The clock enable signal CKE2 is input to the clock controller CKC2 of the task controller TC2. The clock controller CKC2 outputs a clock CLK2 based on the clock enable signal CKE2. The latter data path LDP is operated according to the clock CLK2. Since the clock CLK2 is output from the clock controller CKC2 only when the clock enable signal CKE2 is input, power consumption can be reduced. Note that the clock supply/stop may be controlled for every component of the data processing unit DPU2 that is included in the latter data path LDP, or the data memory DM1 or DM2.

The image data DAT2 which is processed by the data processing unit DPU2 is stored in the shared memory SM through the data interface DIF2 and the extension instruction controller EIC2.

As stated above, in the stream processor according to the first exemplary embodiment, the status information of the task executed by the multi-task coprocessor CP is fed back to the main processor MP. Accordingly, based on this status information, the multi-task coprocessor controller CPC provided in the main processor MP is able to control the task executed by the multi-task coprocessor CP on every clock.

As stated above, the task management in the stream processor according to the first exemplary embodiment is not interruption processing that requires notification of interruption start from the main processor and notification of interruption end from the coprocessor. Thus the stream processing is not interrupted, and no delay occurs. Therefore, the stream processor according to the first exemplary embodiment is more suitable for real-time control compared with the stream processor disclosed in Published Japanese Translation of PCT International Publication for Patent Application, No. 2005-532604.

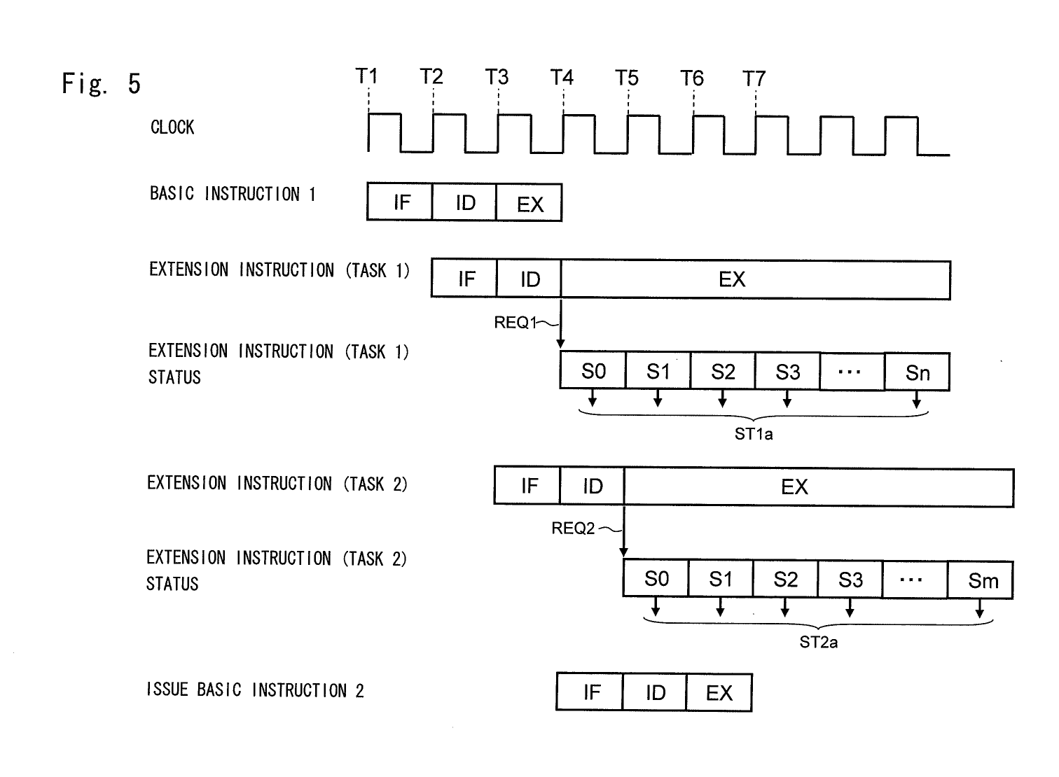

Referring next to FIG. 5, pipeline processing executed by the stream processor according to the first exemplary embodiment will be described. FIG. 5 is a timing chart showing the pipeline processing executed by the stream processor according to the first exemplary embodiment. The pipeline processing is three-stage pipeline processing including an IF phase, an ID phase, and an EX phase. In the IF phase, an instruction is fetched. In the ID phase, the instruction is decoded. In the EX phase, the instruction is executed.

FIG. 5 shows, from the top to the bottom, clock, basic instruction 1, extension instruction (task 1), extension instruction (task 1) status, extension instruction (task 2), extension instruction (task 2) status, and basic instruction 2. The extension instruction (task 1) and the extension instruction (task 2) are loop processing, and successively and repeatedly executed. One frame is processed by one set of the extension instruction (task 1) and the extension instruction (task 2). Although the extension instruction (task 1) and the extension instruction (task 2) according to the first exemplary embodiment are not parallel instructions using a VLIW or a superscalar architecture or the like, they may be such parallel instructions.

As shown in FIG. 5, the basic instruction 1 is fetched from the instruction memory IM at time T1, and at next clock (time T2), the basic instruction 1 is decoded by the instruction decoder ID. At the same timing, the extension instruction (task 1) is fetched from the extension instruction controller EIC1.

At next clock (time T3), the basic instruction 1 is executed by the main processor MP. The basic instruction 1 includes initial setting, for example. At the same timing, the extension instruction (task 1) is decoded by the extension instruction decoder EID1. Further, the extension instruction (task 2) is fetched from the extension instruction controller EIC2.

At next clock (time T4), the execution of the extension instruction (task 1) is started by the data processing unit DPU1. The execution time of the extension instruction (task 1) is longer than that of the basic instruction. When the extension instruction (task 1) is decoded, the request signal REQ1 is output from the extension instruction controller EIC1 to the state machine SMC1. Accordingly, at the same time the extension instruction (task 1) transits to the EX stage, the state machine SMC1 starts issuing the status information ST1a of the EX stage. As described with reference to FIG. 4, the status information ST1a is fed back to the extension instruction controller EIC1 through the status memory STM1.

In the example shown in FIG. 5, the EX stage of the extension instruction (task 1) includes n+1 (n is 0 or any natural number) status from S0 to Sn, and the status sequentially transits for each clock. Note that the status may not necessarily transit sequentially.

At the same timing (time T4), the extension instruction (task 2) is decoded by the extension instruction decoder EID2. Further, the basic instruction 2 is fetched from the instruction memory IM.

At next clock (time T5), the execution of the extension instruction (task 2) is started by the data processing unit DPU2. The execution time of the extension instruction (task 2) is longer than that of the basic instruction. When the extension instruction (task 2) is decoded, the request signal REQ2 is output from the extension instruction controller EIC2 to the state machine SMC2. Accordingly, at the same time the extension instruction (task 2) transits to the EX stage, the state machine SMC2 starts issuing the status information ST2a of the EX stage. As described with reference to FIG. 4, the status information ST2a is fed back to the extension instruction controller EIC2 through the status memory STM2.

In the example shown in FIG. 5, the EX stage of the extension instruction (task 2) includes m+1 (m is 0 or any natural number) status from S0 to Sm, and the status sequentially transits for each clock. Note that the status may not necessarily transit sequentially.

At the same timing (time T5), the basic instruction 2 is decoded by the instruction decoder ID. At next clock (time T6), the basic instruction 2 is executed by the main processor MP. The basic instruction 2 is a branch instruction to go back to the basic instruction 1 to start the image processing of the next frame, for example.

From time T6 to T7, the EX stages of the three instructions including the extension instruction (task 1), the extension instruction (task 2), and the basic instruction 2 are executed in parallel. Especially, while the extension instruction (task 1) and the extension instruction (task 2) are executed in the multi-task coprocessor CP, the basic instruction 2 is executed in the background by the main processor MP. At the same time the status of the extension instruction (task 1) for a frame under processing becomes Sn, the extension instruction (task 1) for the next frame is issued based on the basic instruction 2. Similarly, at the same time the status of the extension instruction (task 2) for a frame under processing becomes Sm, the extension instruction (task 2) for the next frame is issued.

As discussed above, in the stream processor according to the first exemplary embodiment, the multi-task coprocessor controller CPC of the main processor MP is able to manage the task executed by the multi-task coprocessor CP by fine timing control on every clock. This management is performed based on the various instructions executed in the background by the main processor MP and the status information fed back from the multi-task coprocessor CP. More specifically, in the specific status, the multi-task coprocessor controller is able to issue an extension instruction, or start or stop the tasks based on the various instructions. Accordingly, the specification of the stream processor may be easily and promptly changed by programs. As a matter of fact, the various instructions are not limited to the specific instructions.

As stated above, the task management in the stream processor according to the first exemplary embodiment is not interruption processing that requires notification of interruption start from the main processor and notification of interruption end from the coprocessor. Thus the stream processing is not interrupted, and no delay occurs. Therefore, the stream processor according to the first exemplary embodiment is more suitable for real-time control compared with the stream processor disclosed in Published Japanese Translation of PCT International Publication for Patent Application, No. 2005-532604. The same effect can be produced by using a single-task coprocessor instead of using the multi-task coprocessor.

The stream processor according to the first exemplary embodiment is able to sequentially operate according to the operation rate of the stream processing, thereby reducing the capacity of the data memory. Further, the stream processor is able to increase the number of tasks performed in parallel without increasing the operation frequency, thereby reducing power consumption.

The stream processor according to the first exemplary embodiment can easily connect (plug in) a plurality of multi-task coprocessors in order to increase the number of tasks performed in parallel in the stream processing. Alternatively, a multi-task coprocessor having other functions may easily be connected (plugged-in). In short, since the stream processor according to the first exemplary embodiment has a scalability of the plug-in approach, it does not need to have any redundant functions or performance. The optimal hardware can be thus obtained.

### Second Exemplary Embodiment

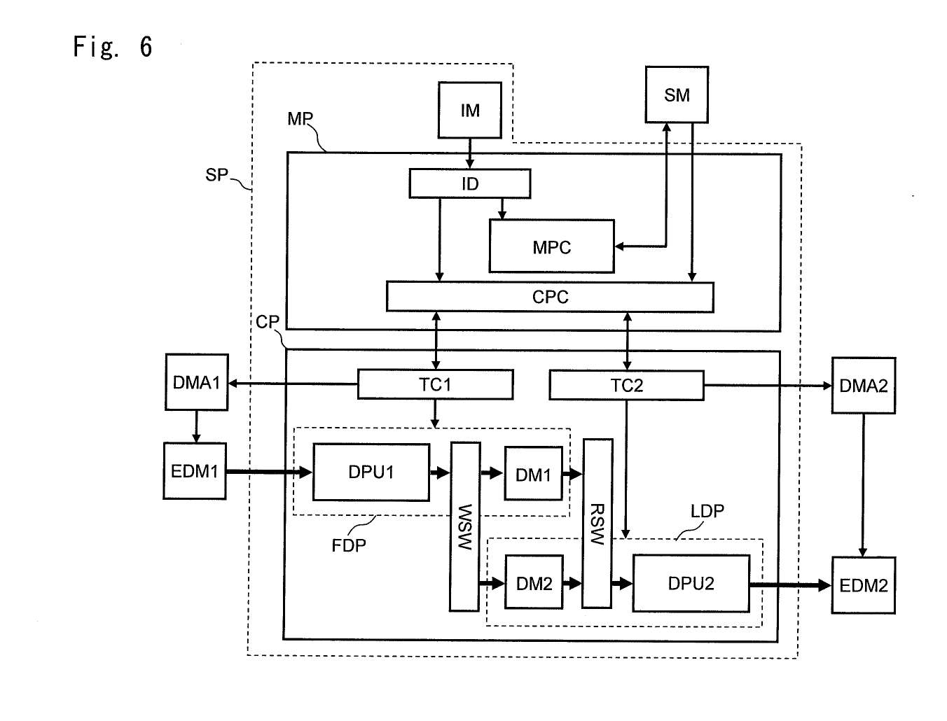

FIG. 6 is a block diagram of a stream processor according to a second exemplary embodiment of the present invention. The second exemplary embodiment is different from the first exemplary embodiment in that two DMA circuits DMA1 and DMA2, and two external data memories EDM1 and EDM2 are additionally provided. The received image data is stored in the external data memory EDM1. Further, the image data that is processed in two stages by the data processing unit DPU1 and the data processing unit DPU2 is stored in the external data memory EDM2.

Accordingly, in the second exemplary embodiment, the DMA circuit DMA1 accesses the external data memory EDM1 based on the extension instruction (task 1) from the task controller TC1. Thus, the image data stored in the external data memory EDM1 is input to the data processing unit DPU1 and is processed based on the extension instruction (task 1).

Further, in the second exemplary embodiment, the DMA circuit DMA2 accesses the external data memory EDM2 based on the extension instruction (task 1) from the task controller TC2. Accordingly, the image data which is processed by the data processing unit DPU2 is stored in the external data memory EDM2. The other structures and effects are similar to those shown in the first exemplary embodiment, and description will be omitted.

Note that the present invention is not limited to the above-described exemplary embodiments, but can be changed as appropriate without departing from the spirit of the present invention. Especially, various types of shared memory, external data memory, and data memory may be possibly used.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A stream processor comprising:
a programmable main processor, and
a coprocessor that executes an extension instruction, the extension instruction being different from a basic instruction executed by the main processor, wherein
the main processor comprises a coprocessor controller, the coprocessor controller outputting the extension instruction to the coprocessor,
the coprocessor comprises a task controller, the task controller controlling a task performed based on the extension instruction and outputting status information of the task, and
the coprocessor controller controls the coprocessor based on the status information and a basic instruction executed by the main processor in background in advance.

2. The stream processor according to claim 1, wherein the task controller outputs the status information on every clock.

3. The stream processor according to claim 1, wherein the task controller further comprises a state machine that outputs the status information based on the extension instruction.

4. The stream processor according to claim 1, wherein the coprocessor comprises a plurality of task controllers, and the coprocessor is capable of processing a plurality of extension instructions input to each of the task controllers in parallel.

5. The stream processor according to claim 4, wherein the plurality of task controllers include first and second task controllers,
the coprocessor further comprises:
first and second data processing units that are controlled by the first and the second task controllers, respectively; and
first and second data memories that store data processed by the first data processing unit,
the second data processing unit reads out and processes data stored in the second data memory during a time at which the data processed by the first data processing unit is stored in the first data memory, and
the second data processing unit reads out and processes data stored in the first data memory during a time at which the data processed by the first data processing unit is stored in the second data memory.

6. A task management method of a stream processor, the stream processor comprising a programmable main processor and a coprocessor, the coprocessor executing an extension instruction which is different from a basic instruction executed by the main processor, wherein
the main processor outputs the extension instruction to the coprocessor,
the coprocessor outputs status information of a task performed based on the extension instruction, and
the main processor controls the coprocessor based on the status information and a basic instruction executed by the main processor in background in advance.

7. The task management method of the stream processor according to claim 6, wherein the coprocessor outputs the status information on every clock.

8. The task management method of the stream processor according to claim 6, wherein the coprocessor is able to process a plurality of extension instructions in parallel.
